(19) United States
(12) Patent Application Publication
(10) Pub. No.: US 2025/0042292 A1
(43) Pub. Date: Feb. 6, 2025

(54) CHARGING MODULE, CHARGING PILE AND CHARGING METHOD USING THE SAME

(71) Applicants: LITE-ON SINGAPORE PTE. LTD., Singapore (SG); LITE-ON TECHNOLOGY CORPORATION, Taipei (TW)

(72) Inventors: Zhiming ZHONG, Singapore (SG); Ken Weng KOW, Singapore (SG); Jing YANG, Singapore (SG); Tse-Chun WANG, Taipei (TW); Wei CIOU, Taipei (TW); Tsung-Hung TSAI, Taipei (TW); Ta-Wei HO, Taipei (TW)

(21) Appl. No.: 18/381,657

(22) Filed: Oct. 19, 2023

(30) Foreign Application Priority Data
Aug. 1, 2023 (TW) 112128817

(51) Int. Cl. B60L 53/67; B60L 53/63; B60L 53/65; G06Q 50/06

(52) U.S. Cl. CPC B60L 53/67; B60L 53/63; B60L 53/65; G06Q 50/06

(57) ABSTRACT

A charging module configured to charge a plurality of electric vehicles through a plurality of charging piles is provided. The charging module includes a charging prediction mode and a charging scheduling unit. The charging prediction mode is obtained according to a plurality of historical charging data, wherein each historical charging data includes an actual charging amount and at least one of a stay time and a charging time. The charging scheduling unit is configured to obtain a predicted electricity demand and a predicted stay period of each electric vehicle through the charging prediction model; and generate a charging schedule including: providing each electric vehicle with a basic charging amount; and determining a charging priority of the electric vehicles according to the predicted electricity demand and the predicted stay period.

This application claims the benefit of Taiwan application Serial No. 112128817, filed Aug. 1, 2023, the subject matter of which is incorporated herein by reference.

### FIELD OF THE INVENTION

The invention relates to a charging module, a charging pile and a charging method using the same.

### BACKGROUND OF THE INVENTION

International efforts to reduce global warming have begun, and the development of propulsion electric vehicles has reached a goal of prohibiting fuel consumption. The charging equipment business notices a trend of electrification of transportation, and accordingly actively establishes a plurality of charging stations across the country and home charging piles, so that more and more electric vehicles could be charged. Thus, a kind of efficient charging method which maximizes the charging efficiency of the charging station is required to be provided and also the amount of power that could be acquired by each electric vehicle at the charging station.

### SUMMARY OF THE INVENTION

In an embodiment of the invention, a charging module configured to charge a plurality of electric vehicles through a plurality of charging piles is provided. The charging module includes a charging prediction mode and a charging scheduling unit. The charging prediction mode is obtained according to a plurality of historical charging data, wherein each historical charging data includes an actual charging amount and at least one of a stay time and a charging time. The charging scheduling unit is configured to obtain a predicted electricity demand and a predicted stay period of each electric vehicle through the charging prediction model; and generate a charging schedule including: providing each electric vehicle with a basic charging amount; and determining a charging priority of the electric vehicles according to the predicted electricity demand and the predicted stay period.

In another embodiment of the invention, a charging module configured to charge a plurality of electric vehicles through a plurality of charging piles is provided. The charging module includes a charging prediction model and a charging scheduling unit. The charging prediction model is obtained according on a plurality of historical charging data, wherein each historical charging data includes an actual charging amount and at least one of a stay time and a charging time. The charging scheduling unit is configured to obtain a predicted electricity demand and a predicted stay period of each electric vehicle through the charging prediction model; and generate a charging schedule including: determining an actual charging amount of each electric vehicle in a manner that maximizes the sum of a plurality of charging ratios of the electric vehicles, wherein each charging ratio is a ratio of the corresponding actual charging amount to the predicted electricity demand.

In another embodiment of the invention, a charging method configured to charge a plurality of electric vehicles is provided. The charging method includes the following steps: obtaining a predicted electricity demand and a predicted stay period of each electric vehicle through a charging prediction model, wherein the charging prediction model is obtained according to a plurality of historical charging data; and proposing a charging schedule, including: providing each electric vehicle with a basic charging amount; and determining a charging priority of the electric vehicles according to the predicted electricity demand and the predicted stay period. Wherein each historical charging data includes an actual charging amount and at least one of a stay time and a charging time.

In another embodiment of the invention, a charging method configured to charge a plurality of electric vehicles is provided. The charging method includes the following steps: obtaining a predicted electricity demand and a predicted stay period of each electric vehicle through a charging prediction model, wherein the charging prediction model is obtained according on a plurality of historical charging data, and each historical charging data includes an actual charging amount and at least one of a stay time and a charging time; and proposing a charging schedule, including: determining an actual charging amount of each electric vehicle in a manner that maximizes the sum of a plurality of charging ratios of the electric vehicles, wherein each charging ratio is a ratio of the corresponding actual charging amount to the predicted electricity demand.

In another embodiment of the invention, a charging pile configured to be electrically connected with one of the charging modules as described above is provided. The charging pile includes a connector and a controller. The connector is configured to be connected with a connected one of the electric vehicles. The controller is configured to receive the electric vehicle identification data of the connected one; and transmit the electric vehicle identification data to the charging module.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the invention will become more readily apparent to those ordinarily skilled in the art after reviewing the following detailed description and accompanying drawings, in which:

FIG. 1 illustrates a diagram view of a charging system according to an embodiment of the invention;

FIG. 2 illustrates a diagram view of a relationship between charging amount and time of a charging station according to an embodiment of the invention; and

FIGS. 3 to 5 illustrate flow charts of the charging methods of the charging module or the charging system in FIG. 1.

### DETAILED DESCRIPTION OF PREFERRED EMBODIMENTS

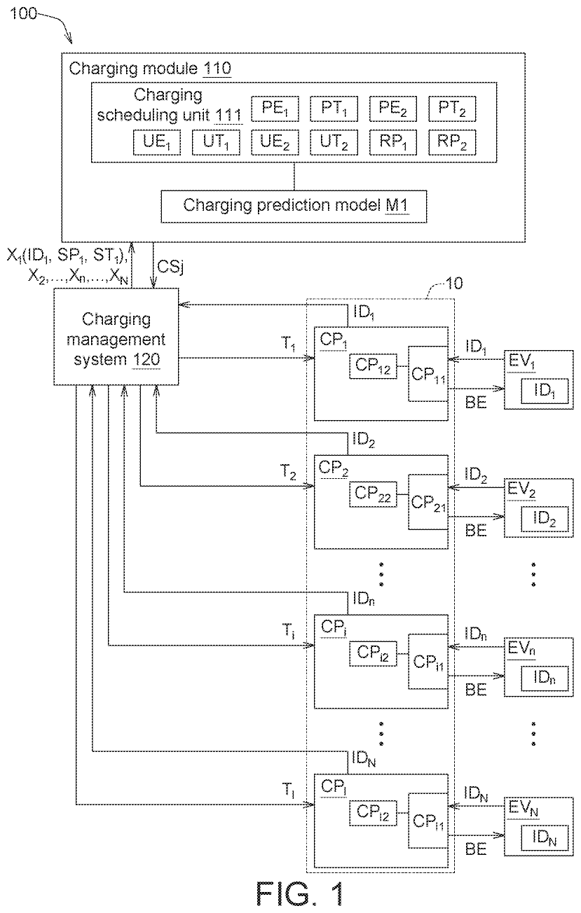

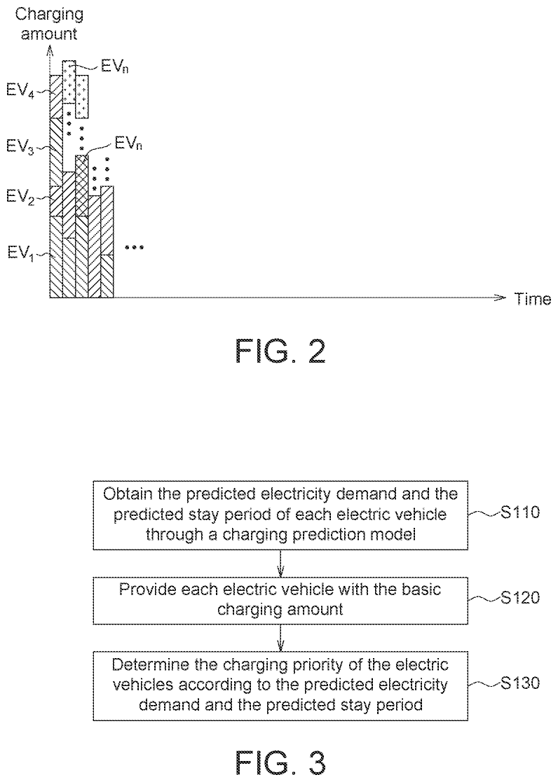

Referring to FIGS. 1 and 2, FIG. 1 illustrates a diagram view of a charging system 100 according to an embodiment of the invention, and FIG. 2 illustrates a diagram view of a relationship between charging amount and time of a charging station according to an embodiment of the invention.

As shown in FIG. 1, the charging system 100 includes a charging module 110, a charging management system 120 and at least one charging station 10. The charging module 110 and the charging management module 120 may be configured in a cloud. In an embodiment, the charging module 110 and the charging management module 120 may be configured in a cloud (not shown) on the internet and communicate with the charging station 10 over the internet. In an embodiment, the charging module 110 and the charging management module 120 may be configured separately (as shown in FIG. 1), and they may communicate with each other through wired technology or wireless communication technology. In other embodiments, the charging module 110 and the charging management module 120 may be integrated into a single module (not shown).

As shown in FIG. 1, each charging station may include I charging piles CPᵢ, wherein i is a positive integer between 1 and I, and I may be a positive integer greater than or equal to 2. The charging module 110 is configured to charge N electric vehicles EVₙ through a plurality of charging piles CPᵢ, where n is, for example, a positive integer between 1 and N, and N may be a positive integer greater than or equal to 1. At different time periods, the number of electric vehicles entering and exiting the charging station is variable (changes), so the value of N is also variable (changes). The charging module 110 and/or the charging management module 120 are, for example, physical circuits formed by at least one semiconductor process, such as semiconductor wafers, semiconductor packages, etc. The charging method in the present embodiment may be implemented by a software or firmware, and is loaded and executed by the charging module 110 and/or the charging management module 120. In addition, the charging system 100, the charging module 110 and/or the charging management module 120 comply with the OCPP (Open Charge Point Protocol) protocol (for example, comply with OCPP 1.6 and 2.0.1), which is an application layer communication protocol between charging piles and a central management system of the electric vehicle and is also called a charging station network. In addition, the electric vehicle EVₙ is, for example, an electric car (passenger car, bus, truck, van, etc.), an electric motorcycle, or the like.

In addition, the application complies with a development trend of the energy industry. In detail, the charging system 100 or the charging management model 120 follows the OCPP exchange agreement, collect the charging transaction information from the charging piles, such as charging time (a time difference between the charging start timepoint and the charging stop timepoint), stay time, an actual charging amount and/or electric power source (solar power, wind power, etc.), etc. The charging system 100 or the charging management model 120 transmits the green charging transaction consultation to the third-party carbon trading manager through OCPI (Open Charge Point Interface) exchange protocol. The third-party carbon trading manager inspects, and send carbon credits back the charging point operator (CPO) through OCPI exchange protocol.

In the present embodiment, the charging module 110 may provide a charging schedule to the charging management module 120, and the charging management module 120 actually controls the charging pile CPᵢ to charge the electric vehicle EVₙ according to the charging schedule.

As shown in FIG. 1, the charging module 110 includes a charging scheduling unit 111 and a charging prediction model M1. The charging scheduling unit 111 is, for example, a physical circuit formed by at least one semiconductor process, wherein the physical circuit is, for example, a semiconductor chip, a semiconductor package, etc. The charging method herein may be implemented by a software or firmware, and is loaded and executed by the charging scheduling unit 111, for example. The charging prediction model M1 is obtained based on a historical charging data. For example, the charging module 110 may use any suitable or even known machine learning technology (for example, deep learning, etc.) to train a plurality of the historical charging data to obtain the charging prediction model M1. As long as the charging prediction model M1 can be obtained, the technology and/or process for obtaining the charging prediction model M1 is not the main requirement of this application, and it does not affect the problem that this application aims to solve or the technical effects that this application can achieve. In an embodiment, the historical charging data includes stay time, charging time, charging location and/or actual charging amount of each of the electric vehicles EVₙ during the training period. The “time” in this article includes, for example, date and/or time point (hour, minute, second). “stay time” is, for example, a time difference between the arrival time (arrival at the charging station) and the departure time (departure from the charging station) of the electric vehicle (departure time: the time when the electric vehicle departures from the charging station or disconnects from the charging pile), and “charging time” is, for example, a time difference between the time when charging of the electric vehicle starts and the time when charging stops. In addition, the time when charging stops is not equivalent to the time when the vehicle departure from the station. During the stay time of the electric vehicle, depending on the charging schedule, charging may be stopped at least once. The reason for stopping charging may be that the electric vehicle is fully charged or the battery of the electric vehicle is overheated.

As shown in FIG. 1, the charging scheduling unit 111 is further configured to: (1). receive an electric vehicle identification data IDₙ, the charging start timepoint STₙ and the charging location SPₙ of each electric vehicle EVₙ sent from the charging management module 120; and (2). obtain a predicted electricity demand PEₙ and a predicted stay period PTₙ of the electric vehicle EVₙ, through the charging prediction model M1, according to the electric vehicle identification data IDₙ, the charging start time point STₙ and the charging location SPA. In other words, for the charging prediction model M1, the inputs Xₙ are the electric vehicle identification data IDₙ, the charging start timepoint STₙ and the charging location SPₙ, and the outputs are the corresponding predicted electricity demand PEₙ and predicted stay period PTₙ.

“Electricity” in this article is, for example, “work”, and its unit is, for example, kilowatt hours (kWh) or other work units.

In an embodiment, the electric vehicle identification data IDₙ may be stored in the electric vehicle EVₙ, and different electric vehicle EVₙ has different electric vehicle identification data IDₙ. The charging location SPₙ represents, for example, the location of the charging pile CPᵢ, and the information of the charging location SPₙ may be stored in the charging management system 120. For example, when the electric vehicle EVₙ is connected to the charging pile CPᵢ, the charging pile CPᵢ may send its charging pile identification information (not shown) to the charging management module 120, and the charging management module 120 may query the corresponding charging location SPₙ accordingly. Although not shown, in another embodiment, the user may send a user charging instruction to the charging management module 120 through an application program (APP) of his communication device (for example, a mobile phone). The user charging instruction includes the charging pile identification information or the charging location SPₙ of the charging pile CPᵢ (for example, the user may input the charging pile identification information of the charging pile CPᵢ or scan the barcode containing the charging pile identification information), and the charging management module 120 may obtain the charging location SPₙ according to the user charging instruction. When the electric vehicle EVₙ is connected to the charging pile CPᵢ, the electric vehicle identification data IDₙ of the electric vehicle EVₙ may be transmitted to the charging module 110 through the charging management module 120, and the charging management module 120 may transmit the charging start timepoint STₙ, the charging location SPₙ and the electric vehicle identification data IDₙ of each charging pile CPi to the charging module 110. For the same charging pile CPᵢ, its associated the charging location SPₙ, the charging start timepoint STₙ and the electric vehicle identification data IDₙ are collectively referred to as the input X₁. For example, the input X₁ includes the charging location SP₁ and the charging start time point ST₁ of the charging pile CP₁, as well as the electric vehicle identification data ID₁ of the electric vehicle EV₁ connected thereto.

In an embodiment, the charging scheduling unit 111 is further configured to: (1). obtain the predicted electricity demand PEⁿ and the predicted stay period PTₙ of each electric vehicle EVₙ through the charging prediction model M1; and (2). generate a charging schedule CSⱼ, which includes: (2-1). determine a charging priority order of the electric vehicles EVₙ according to the predicted electricity demand PEₙ and the predicted stay period PTₙ. Through the charging schedule CSⱼ, in addition to maximizing the charging efficiency of the charging station, each electric vehicle at the charging station may obtain sufficient or expected power as much as possible.

In an embodiment, the basic charging amount BE is, for example, the amount of electricity required by the electric vehicle for one day, such as 10 kWh, but it may be larger or smaller. The basic charging amount BE provided by the charging station to each electric vehicle EVₙ is the same, but it may also vary depending on the specification of the electric vehicle EVₙ. The basic charging amount BE may be set or changed by the charging module 110. The charging scheduling unit 111 may provide the basic charging amount BE to each electric vehicle EVₙ in the charging station, and then provide different or corresponding charging amounts to each electric vehicle EVₙ according to the charging priority order. Every once in a while, the charging scheduling unit 111 may generate the corresponding j^{th} charging schedule CSⱼ, in which the value (e.g., a positive integer) of j may accumulate over time. In two time periods, if the number of electric vehicles EVₙ is different, the charging schedule CSⱼ may also change accordingly.

Taking the electric vehicle EV₁ and the electric vehicle EV₂ as examples, during a period of time (for example, the charging schedule CS₁), the charging scheduling unit 111 obtains the predicted electricity demand PE₁ of the electric vehicle EV₁ which is 50 kWh, and the predicted stay period PT₁ which is 5 hours through the charging prediction model M1, while obtain the predicted electricity demand PE₂ of the electric vehicle EV₂ which is 20 kWh and the predicted stay period PT₂ which is 6 hours.

In an embodiment, the charging scheduling unit 111 is further configured to: (a). obtain the update electricity demand UEₙ and the update stay period UTₙ of each electric vehicle EVₙ after charging; (b). obtain a priority ratio RPₙ of the update electricity demand UEₙ to the update stay period UTₙ of each electric vehicle EVₙ; and (c). determine a charging sequence of the electric vehicles EVₙ based on the order of a plurality of the priority ratios RPₙ from largest to smallest.

Taking the electric vehicle EV₁ and the electric vehicle EV₂ as an example, in the next period (for example, charging schedule CS₂), for example, after charging (for example, after obtaining the basic charging amount BE), the update electricity demand UE₁ of the electric vehicle EV₁ is 40 kWh and the update stay period UT₁ of the electric vehicle EV₁ is 4 hours, while the update electricity demand UE₂ of the electric vehicle EV₂ is 10 kWh and the update stay period UT₂ of the electric vehicle EV₂ is 5 hours. The charging scheduling unit 111 may obtain the update electricity demand UE₁ and the update stay period UT₁ of the electric vehicle EV₁ and the update electricity demand UE₂ and the update stay period UT₂ of the electric vehicle EV₂. The charging scheduling unit 111 may obtain the priority ratio RP₁ between the update electricity demand UE₁ and the update stay period UT₁ of the electric vehicle EV₁ being 10, and obtain the priority ratio RP₂ between the update electricity demand UE₂ and the update stay period UT₂ of the electric vehicle EV₂ being 2. The charging module 110 may determine the charging sequence of the electric vehicles EV₁ and EV₂ according to the priority ratios RP₁ and RP₂ in the order from largest to smallest. In the present embodiment, due to the priority ratio RP₁ being greater than the priority ratio RP₂, the charging module 110 provides the corresponding charging schedule CSⱼ to the charging management module 120, and the charging management module 120 gives priority to charging the electric vehicle EV₁ according to the charging schedule CSⱼ.

Taking the electric vehicle EV₁ and the electric vehicle EV₂ as an example, in the next period (for example, charging schedule CS₃), assuming that after charging for 3 hours, the update electricity demand UE₁ of the electric vehicle EV₁ is 10 kWh and the update stay period UT1 of the electric vehicle EV₁ is 1 hour, and the update electricity demand UE₂ of the electric vehicle EV₂ is 10 kWh and the update dwell period UT₂ of the electric vehicle EV₂ is 2 hours (for example, the electric vehicle EV₁ is in the priority charging schedule and the electric vehicle EV₂ is not charged). The charging scheduling unit 111 may obtain the update electricity demand UE₁ and the update stay period UT₁ of the electric vehicle EV₁ and the update electricity demand UE₂ and the update stay period UT₂ of the electric vehicle EV₂. The charging scheduling unit 111 may obtain the priority ratio RP₁ between the update electricity demand UE₁ and the update stay period UT₁ of the electric vehicle EV₁ being 10, and the priority ratio RP₂ between the update electricity demand UE₂ and the update stay period UT₂ of the electric vehicle EV₂ being 5. The charging module 110 may determine the charging sequence of the electric vehicles EV₁ and EV₂ according to the priority ratios RP₁ and RP₂ in the order from largest to smallest. In the present embodiment, due to the priority ratio RP₁ being greater than the priority ratio RP₂, the charging module 110 provides the corresponding charging schedule CSⱼ to the charging management module 120, and the charging management module 120 gives priority to charging the electric vehicle EV₁ according to the charging schedule CSⱼ.

In the next period (for example, the charging schedule CSⱼ, j 4), the charging module 110 may determine the update charging priorities of the electric vehicles EV₁ and EV₂, using the same method, until the electric vehicle EVₙ is fully charged or the vehicle EVₙ departure from the charging station.

In addition, during the charging process, assuming that the electric vehicle can only receive 5 kWh, the charging module 110 and/or the charging management module 120 may know whether the electric vehicle is fully charged or can no longer be charged from the data fed back by the charging pile. If so, the charging module 110 may accordingly update the charging schedule. For example, when the electric vehicle can no longer receive electricity, the charging module 110 may modify the electricity demand of the electric vehicle to 0 in the next charging schedule.

As described above, the “charging priority order” is not determined according to the time of the electric vehicle being connected to the charging pile or the electric vehicle enters the charging station, but is determined according to its power demand and/or stay time.

As shown in FIG. 2, for the same electric vehicle EVₙ, at different time periods, the charging station may provide different charging amounts to the electric vehicle EVₙ. Alternatively, for the same electric vehicle EVₙ, the electric vehicle may not receive electricity from the charging station every time period. Alternatively, at the same time period, one, some or all of all electric vehicles EVₙ connected to the charging piles in the charging station may receive electricity supply from the charging station. The aforementioned variable charging schedule is designed to maximize the charging efficiency of the charging station and allow each electric vehicle EVₙ to obtain sufficient or expected electricity.

In an embodiment, the charging scheduling unit 111 is further configured to determine the maximum rechargeable number of the electric vehicles EVₙ that may be charged simultaneously according to a rated output power of the charging station. Such maximum rechargeable number may be equal to or less than the total number of EVₙ of these electric vehicles. Furthermore, the charging scheduling unit 111 may determine the charging priority order of these electric vehicles EVₙ on the premise that: the total output power of all charging piles CPᵢ is not greater than the rated output power of the charging station. For example, there are 8 electric vehicles in the charging station. According to the charging priority order, the total electricity demand of the first 6 electric vehicles will cause the total output power of the charging station to be higher than its rated output power, but be lower than the rated output power for the first 5 electric vehicles, and accordingly the charging station will only charge the first 5 electric vehicles. Under such premise, at the same time period, not all electric vehicles EVₙ are in the charging state, or it is possible that all electric vehicles EVₙ are in the charging state. In another embodiment, the total electricity demand of the first 6 electric vehicles causes the total output power of the charging station to be higher than its rated output power. Although the total electricity demand of the first 5 electric vehicles is lower than the rated output power, the charging station may still charge all six electric vehicles, but proportionately reduce the electricity demand of each electric vehicle. In addition, the charging scheduling unit 111 may make the total output power of the charging station (for example, the total output power of all charging piles CPᵢ) as close as possible to the rated output power for maximizing the charging efficiency of the charging station.

In an embodiment, the charging scheduling unit 111 is further configured to repeat the aforementioned steps (a) to (c) with the goal that the update electricity demand UEₙ of at least some of the electric vehicles EV approaches to be equal. In other words, the charging module 110 of the embodiment of the present invention aims to “enable each electric vehicle in the charging station to obtain the same or close charging amount.”

In an embodiment, the charging scheduling unit t 111 is configured to determine the charging schedule CSⱼ with the goal of “maximizing the total charging ratio of all electric vehicles connected to the charging piles in the charging station.” Taking electric vehicles EV₁ and EV₂ as an example, the predicted electricity demand PE₁ of electric vehicle EV₁ is 30 kWh, while the predicted electricity demand PE₂ of electric vehicle EV₂ is 20 kWh. During the predicted stay period of the two vehicles, the charging station may provide the electric vehicles EV₁ and EV₂ with 40 kWh of the electricity. Under the goal of “maximizing the total charging ratio of all electric vehicles connected to the charging piles in the charging station”, the charging schedule CSⱼ provided by the charging scheduling unit 111 includes: the actual charging amount AE₁ of the electric vehicle EV₁ by the charging pile CP₁ is 20 kWh, and the actual charging amount AE₂ of the electric vehicle EV₂ by the charging pile CP₂ is 20 kWh. As a result, a charging ratio RC₁ of the electric vehicle EV₁ is 0.67 (calculation: the actual charging amount AE₁/the predicted electricity demand PE₁=20/30=0.67), while a charging ratio RC₂ of the electric vehicle EV₁ is 1 (calculation: the actual charging amount AE₂/the predicted electricity demand PE₂=20/20=1), and the total charging ratio is the maximum of 1.67.

In an embodiment, after each electric vehicle obtains the basic charging amount BE, the charging scheduling unit 111 then determines the charging schedule CSⱼ with the goal of “maximizing the total charging ratio of all electric vehicles connected to the charging piles in the charging station”. Taking the electric vehicles EV₁ and EV₂ as an example, assuming that after electric vehicles EV₁ and EV₂ obtain the basic charging amount BE, the update electricity demand UE₁ of the electric vehicle EV₁ is 30 kWh, and the update electricity demand UE₂ of the electric vehicle EV₂ is 20 kWh. During the update stay period of the two vehicles, the charging station may provide the electric vehicles EV₁ and EV₂ with 40 kWh of electricity. With the goal of “maximizing the total charging ratio of all electric vehicles connected to the charging piles in the charging station”, the charging schedule CSⱼ provided by the charging scheduling unit 111 includes: the actual charging amount AE₁ of the electric vehicle EV₁ from the charging pile CP₁ is 20 kWh, and the actual charging amount AE₂ of the electric vehicle EV₂ from the charging pile CP₂ is 20 kWh. As a result, the charging ratio RC₁ of the electric vehicle EV₁ is 0.67 (calculation: the actual charging amount AE₁/the update electricity demand UE₁=20/30=0.67), while the charging ratio RC₂ of the electric vehicle EV₁ is 1 (calculation: the actual charging amount AE₂/the update electricity demand UE₂=20/20=1), and the total charging ratio is the maximum of 1.67.

In an embodiment, the charging scheduling unit 111 is further configured to: determine a charging period of the maximum electricity price profit (for example, for the operator of the charging system 100) from the predicted stay period PTₙ. For example, when the predicted stay period PT₁ of the electric vehicle EV₁ is 5 hours, the charging scheduling unit 111 may charge the electric vehicle EV₁ in a period of the maximum electricity price profit which is selected from the stay period of 5 hours, so that the charging station or station administrators of the charging system may earn higher profits.

In an embodiment, the charging scheduling unit 111 is further configured to: determine whether the electric vehicle meets a highest priority level; if the electric vehicle meets the highest priority level, determine the charging schedule CSⱼ with “the electric vehicle that meets the highest priority level is charged first”. Taking the electric vehicle EV₁ as an example, if the electric vehicle EV₁ is set (such setting is pre-stored in the charging module 110 and/or the charging management module 120) as the “highest priority”, then the electric vehicle EV1 will be set as the first order in the charging schedule CSⱼ. If there are multiple electric vehicles that meet the highest priority level, the charging scheduling unit 111 arranges the charging sequence of these electric vehicles in descending order of the multiple priority ratios of these electric vehicles.

In the present embodiment, the charging management module 120 actually controls the charging pile CP_{I} to charge the electric vehicle EVₙ according to the charging schedule. For example, as shown in FIG. 1, the charging scheduling unit 111 is further configured to: transmit the charging schedule CSⱼ to the charging management module 120, so that the charging management module 120 controls at least one charging pile CPᵢ to charge the electric vehicle EVₙ according to the charging schedule CSⱼ. The charging pile CPᵢ is controlled by the charging management module 120, and the charging management module 120 controls the charging mode of the charging pile CPᵢ according to the charging schedule CSⱼ of the charging module 110.

As shown in FIG. 1, the charging pile CPᵢ may communicate with the charging management module 120 through wireless or wired communication technology. The charging pile CPᵢ includes a connector CPᵢ₁ and a controller CPᵢ₂. The connector CPᵢ₁ is configured to connect to one of the electric vehicles EVₙ, and current may be provided to the electric vehicle EVₙ through the connector CPᵢ₁. The controller CPᵢ₂ is, for example, a physical circuit formed by a semiconductor process, such as a semiconductor chip, a semiconductor package, etc. The controller CPᵢ₂ is configured to: receive the electric vehicle identification data IDₙ of the electric vehicles EVₙ; and transmit the electric vehicle identification data IDₙ, the charging start timepoint STₙ and the charging location SPₙ to the charging module 110. In addition, the controller CPᵢ₂ is further configured to charge the electric vehicle EVₙ according to a charging command Ti transmitted from the charging management module 120. The charging command Ti may be generated by the charging module 110 according to the charging schedule CSⱼ. The charging pile CPᵢ can use, for example, DC or AC charging technology. In terms of DC charging technology, the charging pile CPᵢ may obtain a battery SoC (State of Charge, SoC) of the electric vehicle, and the charging scheduling unit 111 may obtain the predicted electricity demand and/or the update electricity demand according to (or calculate) the SoC of the electric vehicle. In terms of AC charging technology, the charging pile CPᵢ may provide the electric vehicle with a small amount of electricity. If the electric vehicle receives such small amount of electricity, it means that the battery of the electric vehicle has not been fully charged; if the electric vehicle does not receive such small amount of electricity, it means that the battery of the electric vehicle has been fully charged or unable to continue charging.

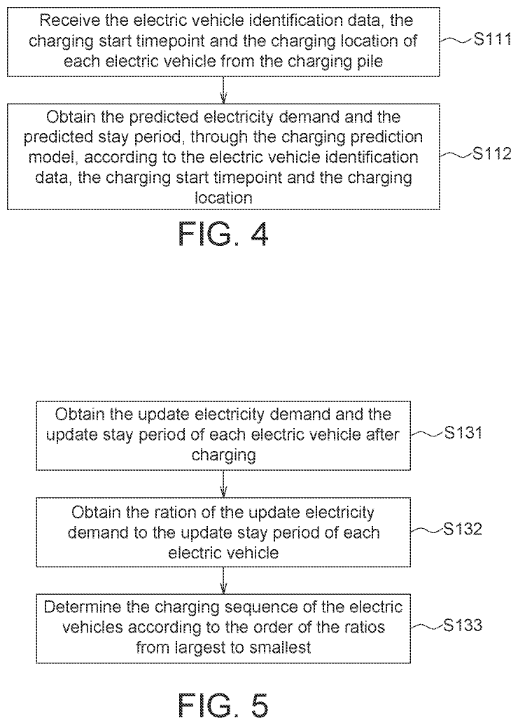

Referring to FIGS. 3 to 5, FIGS. 3 to 5 illustrate flow charts of the charging methods of the charging module 110 or the charging system 100 in FIG. 1.

In step S110, as shown in FIG. 1, the charging module 110 obtains the predicted electricity demand PEₙ and the predicted stay period PTₙ of each electric vehicle EVₙ through the charging prediction model M1.

Then, the charging module 110 proposes or generates a charging schedule CSⱼ, which may be achieved using steps S120 and S130.

In step S120, the charging module 110 provides a basic charging amount BE to each electric vehicle EVₙ.

In step S130, the charging module 110 determines the charging priority order of the electric vehicles EVₙ according to the predicted electricity demand PEₙ and the predicted stay period PTₙ.

In an embodiment, step S110 may include steps S111 and S112 as shown in FIG. 4. In step S111, the charging management module 120 receives the electric vehicle identification data IDₙ of each electric vehicle EVₙ from the charging pile CPᵢ, and transmits the charging start timepoint STₙ and the charging location SPₙ of the charging pile CPᵢ together with the electric vehicle identification data IDₙ to the electric vehicles EVₙ. Then, in step S112, the charging module 110 obtains the predicted electricity demand PEₙ and the predicted stay period PTₙ, through the charging prediction model M1, according to the electric vehicle identification data IDₙ, the charging start timepoint STₙ and the charging location SPₙ.

In an embodiment, step S130 may include steps S131 to S133 as shown in FIG. 5. In step S131, the charging module 110 obtains the update electricity demand UEₙ and the update stay period UTₙ of each electric vehicle EVₙ after charging. In step S132, the charging scheduling unit 111 may obtain the priority ratio RPₙ of the update electricity demand UEₙ to the update stay period UTₙ of each electric vehicle EVₙ. In step S133, the charging scheduling unit 111 determines the charging sequence of the electric vehicles EVₙ according to the descending order of the priority ratios RPₙ.

In summary, the charging system or charging module may obtain the value of the required power of the electric vehicle which connected to the charging pile in the predicted stay period and the stay period to generate (or establish) a charging plan (for example, the charging schedule). The charging plan may be arranged according to different strategies. In addition, the charging system or charging module may also generate or update the charging schedule without knowing the rated power of the electric vehicle for no waste of electricity.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A charging module configured to charge a plurality of electric vehicles through a plurality of charging piles, comprising:
a charging prediction mode obtained according to a plurality of historical charging data, wherein each historical charging data comprises an actual charging amount and at least one of a stay time and a charging time; and
a charging scheduling unit configured to:
obtain a predicted electricity demand and a predicted stay period of each electric vehicle through the charging prediction model; and
generate a charging schedule, comprising:
providing each electric vehicle with a basic charging amount; and
determining a charging priority of the electric vehicles according to the predicted electricity demand and the predicted stay period.

2. The charging module as claimed in claim 1, wherein the charging scheduling unit is configured to:
(a) obtain an update electricity demand and an update stay period of each electric vehicle after charging;
(b) obtain a priority ratio of the update electricity demand to the update stay period for each electric vehicle; and
(c) determine a charging order of the electric vehicles according to a descending order of the priority ratios.

3. The charging module as claimed in claim 2, wherein the charging scheduling unit is further configured to:
determine a maximum rechargeable number of the electric vehicles that are allowed to be charged at the same time according to a rated output power of a charging station.

4. The charging module as claimed in claim 2, wherein the charging scheduling unit is further configured to:
repeat steps (a) to (c) with a goal that the update electricity demands of at least some of the electric vehicles are close to equal.

5. The charging module as claimed in claim 1, wherein the charging scheduling unit is further configured to:
determine a charging period of a maximum electricity price profit from the predicted stay period.

6. The charging module as claimed in claim 1, wherein the charging scheduling unit is further configured to:
receive an electric vehicle identification data, a charging start timepoint and a charging location of each electric vehicle from a charging management module; and
obtain the predicted electricity demand and the predicted stay period, through the charging prediction model according to the electric vehicle identification data, the charging start timepoint and the charging location.

7. The charging module as claimed in claim 1, wherein the charging scheduling unit is further configured to:
transmit the charging schedule to a charging management module, wherein the charging management module is configured to control at least one charging pile to charge at least one electric vehicle according to the charging schedule.

8. A charging module configured to charge a plurality of electric vehicles through a plurality of charging piles, comprising:
a charging prediction model obtained according on a plurality of historical charging data, wherein each historical charging data comprises an actual charging amount and at least one of a stay time and a charging time; and
a charging scheduling unit configured to:
obtain a predicted electricity demand and a predicted stay period of each electric vehicle through the charging prediction model; and
generate a charging schedule, comprising:
determining an actual charging amount of each electric vehicle in a manner that maximizes the sum of a plurality of charging ratios of the electric vehicles, wherein each charging ratio is a ratio of the corresponding actual charging amount to the predicted electricity demand.

9. The charging module as claimed in claim 8, wherein the charging scheduling unit is further configured to:
determine a maximum rechargeable number of the electric vehicles that are allowed to be charged at the same time according to a rated output power of a charging station.

10. The charging module as claimed in claim 8, wherein the charging scheduling unit is further configured to:
determine a charging period of a maximum electricity price profit from the predicted stay period.

11. The charging module as claimed in claim 8, wherein the charging scheduling unit is further configured to:
receive an electric vehicle identification data, a charging start timepoint and a charging location of each electric vehicle from a charging management module; and
obtain the predicted electricity demand and the predicted stay period, through the charging prediction model according to the electric vehicle identification data, the charging start timepoint and the charging location.

12. The charging module as claimed in claim 8, wherein the charging scheduling unit is further configured to:
transmit the charging schedule to a charging management module, wherein the charging management module is configured to control at least one charging pile to charge at least one electric vehicle according to the charging schedule.

13. A charging method configured to charge a plurality of electric vehicles, comprising:
obtaining a predicted electricity demand and a predicted stay period of each electric vehicle through a charging prediction model, wherein the charging prediction model is obtained according to a plurality of historical charging data; and
proposing a charging schedule, comprising:
providing each electric vehicle with a basic charging amount; and
determining a charging priority of the electric vehicles according to the predicted electricity demand and the predicted stay period;
wherein each historical charging data comprises an actual charging amount and at least one of a stay time and a charging time.

14. The charging method as claimed in claim 13, wherein determining the charging priority of the electric vehicles according to the predicted electricity demand and the predicted stay period comprises:
(a) obtaining an update electricity demand and an update stay period of each electric vehicle after charging;
(b) obtaining a priority ratio of the update electricity demand to the update stay period for each electric vehicle; and
(c) determining a charging order of the electric vehicles according to a descending order of the priority ratios.

15. The charging method as claimed in claim 14, wherein determining the charging priority of the electric vehicles according to the predicted electricity demand and the predicted stay period comprises:
determining a maximum rechargeable number of the electric vehicles that are allowed to be charged at the same time according to a rated output power of a charging station.

16. The charging method as claimed in claim 14, wherein determining the charging priority of the electric vehicles according to the predicted electricity demand and the predicted stay period comprises:
repeating steps (a) to (c) with a goal that the update electricity demands of at least some of the electric vehicles are close to equal.

17. The charging method as claimed in claim 13, wherein determining the charging priority of the electric vehicles according to the predicted electricity demand and the predicted stay period comprises:
determining a charging period of a maximum electricity price profit from the predicted stay period.

18. The charging method as claimed in claim 13, wherein obtaining the predicted electricity demand and the predicted stay period of each electric vehicle through the charging prediction model comprises:
receiving an electric vehicle identification data, a charging start timepoint and a charging location of each electric vehicle from a charging management module; and
obtaining the predicted electricity demand and the predicted stay period, through the charging prediction model according to the electric vehicle identification data, the charging start timepoint and the charging location.

19. The charging method as claimed in claim 13, further comprising:
transmitting the charging schedule to a charging management module, wherein the charging management module is configured to control at least one charging pile to charge at least one electric vehicle according to the charging schedule.

20. A charging method configured to charge a plurality of electric vehicles, comprising:
obtaining a predicted electricity demand and a predicted stay period of each electric vehicle through a charging prediction model, wherein the charging prediction model is obtained according on a plurality of historical charging data, and each historical charging data comprises an actual charging amount and at least one of a stay time and a charging time; and
proposing a charging schedule, comprising:
determining an actual charging amount of each electric vehicle in a manner that maximizes the sum of a plurality of charging ratios of the electric vehicles, wherein each charging ratio is a ratio of the corresponding actual charging amount to the predicted electricity demand.

21. The charging method as claimed in claim 20, wherein determining the charging priority of the electric vehicles according to the predicted electricity demand and the predicted stay period comprises:
determining a maximum rechargeable number of the electric vehicles that are allowed to be charged at the same time according to a rated output power of a charging station.

22. The charging method as claimed in claim 20, wherein determining the charging priority of the electric vehicles according to the predicted electricity demand and the predicted stay period comprises:
determining a charging period of a maximum electricity price profit from the predicted stay period.

23. The charging method as claimed in claim 20, wherein obtaining the predicted electricity demand and the predicted stay period of each electric vehicle through the charging prediction model comprises:
receiving an electric vehicle identification data, a charging start timepoint and a charging location of each electric vehicle from a charging management module; and
obtaining the predicted electricity demand and the predicted stay period, through the charging prediction model according to the electric vehicle identification data, the charging start timepoint and the charging location.

24. The charging method as claimed in claim 20, further comprising:
transmitting the charging schedule to a charging management module, wherein the charging management module is configured to control at least one charging pile to charge at least one electric vehicle according to the charging schedule.

25. A charging pile configured to be electrically connected with one of the charging modules as claimed in claim 1, comprising:
a connector configured to be connected with a connected one of the electric vehicles; and
a controller configured to:
receive the electric vehicle identification data of the connected one; and
transmit the electric vehicle identification data to the charging module.

26. The charging pile as claimed in claim 25, wherein the controller is further configured to:
charge the connected one of the electric vehicles according to a charging command transmitted from a charging management module.
